(19) United States
(12) Patent Application Publication
(10) Pub. No.: US 2026/0025036 A1
(43) Pub. Date: Jan. 22, 2026

(54) DRIVE UNIT FOR AN ACTUATING DEVICE OF A BRAKE SYSTEM, AND ACTUATING DEVICE

(71) Applicant: Robert Bosch GmbH, Stuttgart (DE)

(72) Inventors: Florian Kemmer, Bieberehren (DE); Willi Nagel, Remseck/Hochdorf (DE)

(21) Appl. No.: 18/868,494

(22) PCT Filed: May 17, 2023
(86) PCT No.: PCT/EP2023/063303

§ 371 Date: Nov. 22, 2024

(30) Foreign Application Priority Data
May 30, 2022 (DE) 10 2022 205 420.2

(51) Int. Cl. H02K 5/15; F16D 65/28; F16D 121/24; F16D 131/00; H02K 5/173; H02K 7/116

(52) U.S. Cl. CPC H02K 5/15; F16D 65/28; H02K 5/1732; H02K 7/116; F16D 2121/24; F16D 2131/00

(57) ABSTRACT

A drive unit for an actuating device of a brake system. The drive unit includes: a motor housing; an electrical machine arranged in the motor housing, wherein a rotor of the electrical machine is arranged for conjoint rotation on a motor shaft mounted rotatably in the motor housing; and a planetary transmission by way of which the motor shaft is connected or connectable to an actuator element of the actuating device, wherein the planetary transmission has a rotatably mounted planet carrier, and wherein the planet carrier has a carrier portion on which at least one planet gear is rotatably mounted. The drive unit has an end plate arranged on the motor housing, by way of which end plate the planet carrier is mounted on a side of the planet gear facing away from the electrical machine.

### FIELD

The present invention relates to a drive unit for an actuating device of a brake system, having a motor housing; an electrical machine arranged in the motor housing, wherein a rotor of the electrical machine is arranged for conjoint rotation on a motor shaft mounted rotatably in the motor housing, and a planetary transmission by way of which the motor shaft is connected or connectable to an actuator element of the actuating device, wherein the planetary transmission has a rotatably mounted planet carrier, and wherein the planet carrier has a carrier portion on which at least one planet gear is rotatably mounted.

The present invention also relates to an actuating device for a brake system, having an actuator element, and having a drive unit for driving the actuator element.

### BACKGROUND INFORMATION

Drive units of the aforementioned type are described in the related art. With the increasing electrification of motor vehicles, brake system actuators are also becoming increasingly electrified. For this purpose, the actuating devices have a drive unit having an electrical machine arranged in a motor housing. A rotor of the electrical machine is arranged for conjoint rotation on a motor shaft mounted rotatably in the motor housing. In order to achieve a high torque, a planetary transmission is often connected downstream of the motor shaft, so that the motor shaft is connected connectable to an actuator element of the actuating device by way of the planetary transmission. Typically, the planetary transmission has a rotatably mounted planet carrier having a carrier portion on which at least one planet gear is rotatably mounted.

### SUMMARY

A drive unit according to the present invention may have an advantage that the installation of the drive unit in an actuating device is simplified compared to solutions from the related art. According to an example embodiment of the present invention, the drive unit has an end plate arranged on the motor housing, by way of which end plate the planet carrier is mounted on a side of the planet gear facing away from the electrical machine. The mounting of the planet carrier by way of the end plate arranged on the motor housing makes possible a joint handling of the electrical machine and the planetary transmission as a preassembly. Accordingly, the planetary transmission does not have to be connected to the electrical machine or the motor shaft as part of the final assembly of the actuating device. The reduction in assembly work in terms of the final assembly ultimately leads to a reduction in the production costs for the actuating device. Because the end plate supports the planet carrier on the side of the at least one planet gear facing away from the electrical machine, a particularly secure hold of the planet carrier on the end plate and thus on the motor housing is achieved. This is preferably supported by the fact that a part of the pivot bearing that can rotate with the planet carrier forms an axial stop for the carrier portion. Preferably, the end plate is fastened to the motor housing, for example by one or more fastening means. Preferably, a plurality of planet gears are rotatably mounted on the carrier portion, wherein the end plate then supports the planet carrier on the side of the plurality of planet gears facing away from the electrical machine. Preferably, at least three planet gears are rotatably mounted on the carrier portion.

According to a preferred example embodiment of the present invention, the end plate carries a rolling element bearing for mounting the planet carrier. As a result, a low-friction mounting of the planet carrier is achieved. In addition, the position of the planet carrier can be defined particularly precisely due to the rolling element bearing.

According to a preferred example embodiment of the present invention, the end plate abuts the motor housing radially from the inside. Thus, the end plate is arranged at least in portions in the motor housing and thus stowed away in a manner that saves installation space. In addition, a mechanically robust fastening of the end plate to the motor housing can be achieved due to the radial abutment. Preferably, the end plate is pressed into the motor housing and thus fastened to the motor housing by way of an interference fit. Alternatively, the end plate is fastened to the motor housing by means of an adhesive connection or a welded connection, for example.

According to a preferred example embodiment of the present invention, the end plate axially abuts a motor housing flange of the motor housing. Due to such a design of the drive unit, a particularly precise definition of the position of the planet carrier can be achieved by minimizing the tolerance chain. This is explained in more detail below. In particular, the end plate has an end plate flange, wherein the end plate flange axially abuts the motor housing flange in relation to the axis of rotation of the planet carrier.

According to a preferred example embodiment of the present invention, the planet carrier has an output shaft, and the end plate supports the output shaft. Because the end plate supports the output shaft, i.e. a shaft-shaped or axle-shaped element having a comparatively small diameter, a pivot bearing having a small diameter can also be used. As a result, the production costs for the drive unit or the actuating device are further reduced.

According to a preferred example embodiment of the present invention, the carrier portion is arranged in the motor housing and the output shaft protrudes out of the motor housing. Due to the arrangement of the carrier portion in the motor housing, the drive unit is designed to be compact and in a manner that saves installation space. Because the output shaft protrudes out of the motor housing, a coupling in terms of transmission technology of the output shaft having a further transmission element can be implemented easily.

According to a preferred example embodiment of the present invention, the end plate supports a first bearing point of the planet carrier, and the planet carrier has a second bearing point which is arranged on a side of the first bearing point facing away from the electrical machine and is spaced apart from the first bearing point. Due to the provision of two spaced-apart bearing points, a precise mounting of the planet carrier can be achieved. In particular, the introduction of lateral forces into the planetary transmission is at least reduced during operation of the drive unit. If the drive unit is assembled correctly and the elements supporting the bearing points are designed correctly, the introduction of lateral forces into the planetary transmission can even be effectively avoided. Preferably, the output shaft has at least the second bearing position, particularly preferably the first and second bearing point. Preferably, the planet carrier or the output shaft has an output toothing between the bearing points.

According to a preferred example embodiment of the present invention, the drive unit has a further end plate which is arranged between the planetary transmission and the electrical machine and supports the motor shaft. In addition to the end plate bearing the planet carrier, there is also a further end plate bearing the motor shaft. Due to the further end plate, the position of the motor shaft can be precisely defined. Preferably, the carrier portion of the planet carrier is arranged between the end plate and the further end plate.

An actuating device according to the present invention includes the design of the drive unit according to the present invention. This also results in the advantages already mentioned. Further preferred features and combinations of features result from what was described above and from the rest of the disclosure herein.

According to a preferred embodiment of the present invention, the actuating device has a transmission housing fastened to the motor housing, and the second bearing point of the planet carrier is supported by the transmission housing. Due to the mounting of the first and second bearing points of the planet carrier, the introduction of lateral forces into the planetary transmission during operation of the actuating device is effectively avoided.

According to a preferred example embodiment of the present invention, the transmission housing carries a rolling element bearing for mounting the planet carrier. Due to the rolling element bearing, a low-friction mounting of the planet carrier in the transmission housing is achieved. In addition, the position of the second bearing point of the planet carrier can be defined particularly precisely by the rolling element bearing. The rolling element bearing is preferably designed as a needle bearing.

According to an alternative example embodiment of the present invention, the transmission housing preferably has a bearing pin which is fixed to the housing and engages in an end-face recess of the planet carrier for mounting the planet carrier. This design of the actuating device is advantageous in terms of the production costs of the actuating device, because a comparatively expensive rolling element bearing can be dispensed with. Preferably, the bearing pin forms a plain bearing for the planet carrier.

According to a preferred example embodiment of the present invention, the motor housing flange of the motor housing has a plurality of first fastening openings, a transmission housing flange of the transmission housing has a plurality of second fastening openings, each of the first fastening openings is aligned with, in each case, another of the second fastening openings, and the transmission housing is fastened to the motor housing by fastening means inserted into the fastening openings. As a result, a particularly robust mechanical fastening of the motor housing to the transmission housing is achieved. As mentioned above, the end plate preferably abuts the motor housing radially from the inside. In this embodiment, the transmission housing flange preferably directly axially abuts the motor housing flange. As mentioned above, the end plate can also axially abut the motor housing flange. The end plate or the end plate flange of the end plate is then preferably arranged between the motor housing flange and the transmission housing flange. Particularly preferably, the end plate or the end plate flange then has a plurality of third fastening openings, wherein each of the third fastening openings is aligned with, in each case, one of the first fastening openings and, in each case, one of the second fastening openings. The fastening means are then also inserted into the third fastening openings. Preferably, the fastening means are designed as screws.

Particularly preferably, according to an example embodiment of the present invention, the fastening means are designed as dowel screws. A dowel screw is a screw that has a first axial portion and a second axial portion, wherein the first axial portion has a screw thread and wherein the second axial portion is designed as a guide portion. Preferably, the dowel screws are designed such that the guide portions are arranged in the fastening openings at least substantially without radial play. In addition to the mechanically robust fastening of the motor housing to the transmission housing, due to the dowel screws, a precise alignment of the motor housing relative to the transmission housing can also be achieved. This means that the desired alignment of the planet carrier can also be implemented precisely. For example, it can be achieved that an axis of rotation of the planet carrier is aligned parallel to an axis of rotation of the motor shaft. This axis-parallel alignment has the advantage that the introduction of lateral forces into the planetary transmission is reduced particularly effectively. As mentioned above, in a preferred embodiment, the end plate axially abuts the motor housing flange. If dowel screws are used as fastening means, the end plate is also precisely aligned by way of the dowel screws. This is accompanied by a particularly precise definition of the position of the planet carrier, because the tolerance chain is minimized by the direct alignment of the end plate by means of the dowel screws.

According to a preferred example embodiment of the present invention, the motor housing flange has a plurality of first alignment openings, the transmission housing flange has a plurality of second alignment openings, each of the first alignment openings is aligned with, in each case, another of the second alignment openings, and the alignment openings are unoccupied. The alignment openings are unoccupied, so that no fastening means or the like are arranged in the alignment openings when the actuating device is assembled. Thus, the alignment openings are free of fastening means. In this respect, the alignment openings do not contribute to the fastening of the transmission housing to the motor housing. However, the alignment openings offer advantages in terms of the assembly of the actuating device. For example, when assembling the actuating device, the procedure is such that the drive unit is initially provided and arranged on the transmission housing such that the motor housing flange is opposite the transmission housing flange. Subsequently, the desired alignment of the motor housing relative to the transmission housing is achieved by inserting, in each case, a dowel pin through each pair of alignment openings. Subsequently, the transmission housing and the motor housing are fastened to one another, for example by inserting fastening means into the aforementioned fastening openings. However, the fastening can also be achieved in another way, so that the presence of the alignment openings does not necessarily require the presence of the fastening openings. Since the alignment of the transmission housing relative to the motor housing is then fixed by the fastening means, the dowel pins are subsequently preferably removed. Due to the alignment openings, the advantages that have already been explained in connection with the dowel screws can be achieved. As mentioned above, in a preferred embodiment, the end plate axially abuts the motor housing flange. In this embodiment, the end plate preferably has a plurality of third alignment openings, wherein each of the third alignment openings is aligned with, in each case, one of the first alignment openings and, in each case, one of the second alignment openings. If the dowel pins are inserted into the alignment openings, the end plate is also precisely aligned by the dowel pins. As mentioned above, this is accompanied by a particularly precise definition of the position of the planet carrier due to the minimization of the tolerance chain.

The present invention is explained in more detail below with reference to the figures.

### BRIEF DESCRIPTION OF THE DRAWINGS

FIG. 1 is a sectional view of an actuating device for a brake system, according to an example embodiment of the present invention.

FIG. 2 is a detailed perspective view of the control, according to an example embodiment of the present invention.

FIG. 3 is a sectional view of a drive unit of the actuating device according to an example embodiment of the present invention.

FIG. 4 shows the drive unit according to a further exemplary embodiment of the present invention.

### DETAILED DESCRIPTION OF EXAMPLE EMBODIMENTS

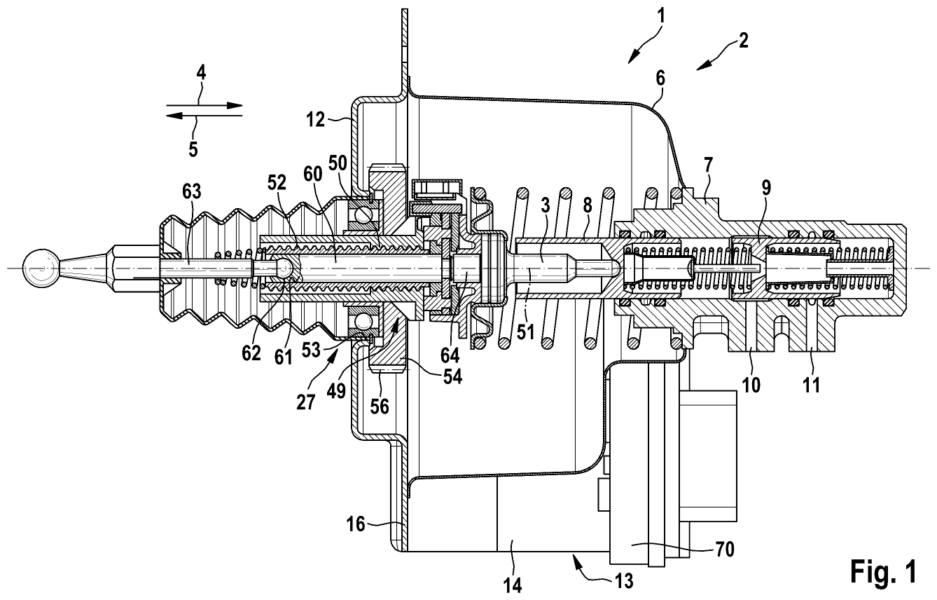

FIG. 1 shows a sectional view of an actuating device 1 for a brake system 2 of a motor vehicle that is not shown in more detail.

The actuating device 1 has a displaceably mounted pressure element 3 or actuator element 3, which in the present case is designed as a pressure rod 3. The actuator element 3 can be displaced in a first direction 4 and in a second direction 5 opposite to the first direction 4. The actuator element 3 is arranged at least partially in a housing 6 of the actuating device 1. A main brake cylinder 7 of the actuating device 1 is arranged in a manner fixed to the housing on the housing 6. A first hydraulic piston 8 and a second hydraulic piston 9 are displaceably mounted in the main brake cylinder 7, namely in the first direction 4 and in the second direction 5. The main brake cylinder 7 has a plurality of hydraulic connections 10, 11. If the actuation device 1 is installed in the brake system 2 as intended, the hydraulic connections 10, 11 are connected in terms of fluid technology to slave cylinders of friction brake devices of the brake system 2. The friction brake devices can then be actuated by displacing the hydraulic pistons 8 and 9 in the first direction 4. The actuator element 3 is coupled to the hydraulic pistons 8 and 9 such that the hydraulic pistons 8, 9 can be displaced in the first direction 4 by the actuator element 3. The friction brake devices can thus be actuated by displacing the actuator element 3.

The actuating device 1 also has a transmission housing 12. The housing 6 and the transmission housing 12 are fastened to one another. In the present case, the transmission housing 12 is shell-shaped.

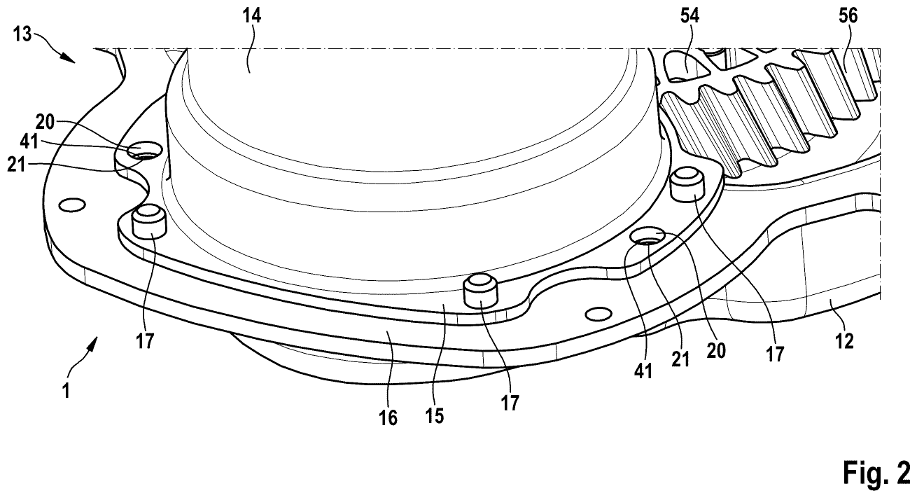

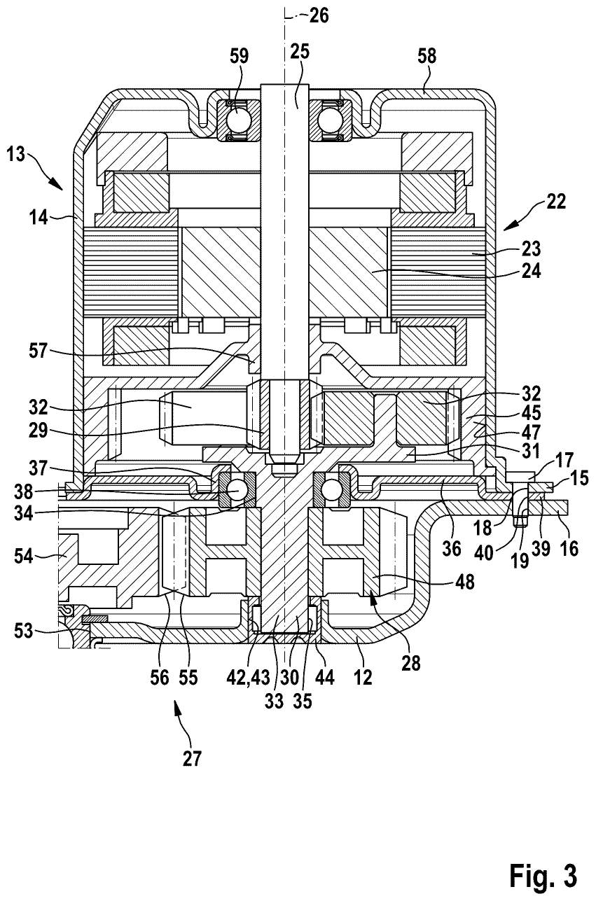

The actuating device 1 also has a drive unit 13. The drive unit 13 has a motor housing 14. The motor housing 14 is fastened to the transmission housing 12. This is explained in more detail below with reference to FIG. 2. FIG. 2 shows a detailed perspective view of the actuating device 1. As can be seen from FIG. 2, the motor housing 14 has a motor housing flange 15 and the transmission housing 12 has a transmission housing flange 16. A mounting surface of the motor housing flange 15 is opposite a mounting surface of the transmission housing flange 16. The motor housing flange 15 is fastened to the transmission housing flange 16 by a plurality of fastening means 17, wherein in the present case the fastening means 17 are designed as screws 17. The fastening means 17 are, in each case, inserted into a first fastening opening 18 of the motor housing flange 15 and, in each case, into a second fastening opening 19 of the transmission housing flange 16. This can be seen by way of example for one of the fastening means 17 in FIG. 3.

The motor housing flange 15 also has a plurality of first alignment openings 20. The transmission housing flange 16 has a plurality of second alignment openings 21, wherein each of the first alignment openings 20 is aligned with, in each case, another of the second alignment openings 21. As can be seen from FIG. 2, the alignment openings 20 and 21 are unoccupied or free of fastening means when the actuating device 1 is assembled. Thus, the alignment openings 20 and 21 do not contribute to the fastening of the transmission housing 12 to the motor housing 14. However, the alignment openings 20 and 21 have advantages when assembling the actuating device 1, as will be explained in more detail below.

The design of the drive unit 13 is explained in more detail below based on FIG. 3. The drive unit 13 has an electrical machine 22 arranged in the motor housing 14. A stator 23 of the electrical machine 22 is arranged in a manner fixed in the motor housing 14. A rotor 24 of the electrical machine 22 is arranged for conjoint rotation on a motor shaft 25. The motor shaft 25 is mounted in the motor housing 14 so that it can rotate about an axis of rotation 26.

The motor shaft 25 is coupled to the actuator element 3 by a transmission device 27 such that the actuator element 3 can be displaced by the electrical machine 22. The transmission device 27 has a planetary transmission 28 that can be driven or rotated by the motor shaft 25. For this purpose, a sun gear 29 of the planetary transmission 28 is arranged for conjoint rotation on the motor shaft 25. The planetary transmission 28 also has a rotatably mounted planet carrier 30. One axis of rotation of the planet carrier 30 corresponds to the axis of rotation 26 of the motor shaft 25. The planet carrier 30 has a plate-shaped carrier portion 31, on which a plurality of planet gears 32 are rotatably mounted. In the present case, three planet gears 32 are rotatably mounted on the carrier portion 31. The carrier portion 31 is arranged in the motor housing 14. The planet carrier 30 also has an output shaft 33, which is arranged on a side of the carrier portion 31 facing away from the electrical machine 22 and is connected to the carrier portion 31 for conjoint rotation. The output shaft 33 protrudes axially out of the motor housing 14 in relation to the axis of rotation of the planet carrier 30.

The planet carrier 30 has a first bearing point 34 and a second bearing point 35. The first bearing point 34 is arranged on a side of the planet gears 32 facing away from the electrical machine 22, adjacent to the carrier portion 31. The second bearing point 35 is arranged on a side of the first bearing point 34 facing away from the electrical machine 22 and is spaced apart from the first bearing point 34. In the present case, the output shaft 33 has bearing points 34 and 35, so that the planet carrier 30 is supported by bearings on the output shaft 33.

The first bearing point 34 is supported by an end plate 36 that is arranged in a manner fixed to the housing on the motor housing 14. For this purpose, the end plate 36 has a sleeve-shaped bearing portion 37, which radially surrounds the output shaft 33 or the planet carrier 30 in the region of the first bearing point 34. The bearing portion 37 carries a rolling element bearing 38, which acts between the bearing portion 37 and the first bearing point 34. According to the exemplary embodiment shown in FIG. 3, the end plate 36 has an end plate flange 39, which axially abuts the motor housing flange 15 in relation to the axis of rotation of the planet carrier 30. Thus, the end plate flange 39 is arranged axially between the motor housing flange 15, on the one hand, and the transmission housing flange 16, on the other hand, when the actuating device 1 is assembled. The end plate flange 39 has a plurality of third fastening openings 40, wherein each of the third fastening openings 40 is aligned with, in each case, another of the first fastening openings 18 and with, in each case, another of the second fastening openings 19. The fastening means 17 are also inserted into the third fastening openings 40. The end plate flange 39 also has a plurality of third alignment openings 41, wherein each of the third alignment openings 41 is aligned with, in each case, another of the first alignment openings 20 and with, in each case, another of the second alignment openings 21. The third alignment openings 41 are also unoccupied or free of fastening means when the actuating device 1 is assembled.

The second bearing point 35 of the planet carrier 30 is supported by the transmission housing 12. According to the exemplary embodiment shown in FIG. 3, the transmission housing 12 has an axial opening 42 into which the output shaft 33 protrudes. A casing inner surface 43 of the transmission housing 12 forming the axial opening 42 carries a rolling element bearing 44, which acts between the second bearing point 35 of the output shaft 33 and the transmission housing 12. In the present case, the rolling element bearing 44 is designed as a needle bearing 44.

The planetary transmission 28 also has a ring gear 45 fixed to the housing. The planet gears 32 mesh with the sun gear 29, on the one hand, and the ring gear 45, on the other hand. An outer casing wall surface 47 of the ring gear 45 abuts the motor housing 14 radially from the inside.

The transmission device 27 also has a gear wheel 48, which is arranged for conjoint rotation on the output shaft 33 or the planet carrier 30, in the present case between the first bearing point 34 and the second bearing point 35. For example, the gear wheel 48 has an unrecognizable internal toothing, which meshes with an unrecognizable output toothing of the output shaft 33 for a connection with conjoint rotation with the output shaft 33.

The transmission device 27 also has a spindle gear 49 having a rotatably mounted spindle nut 50. The axis of rotation 51 of the spindle nut 50 corresponds to the longitudinal center axis of the actuator element 3. In addition, the axis of rotation 51 of the spindle nut 50 is aligned parallel to the axis of rotation 26 of the motor shaft 25 or the planet carrier 30. The spindle gear 49 also has a displaceable threaded spindle 52. The threaded spindle 52 can be displaced by turning the spindle nut 50, namely in the first direction 4 and in the second direction 5. The threaded spindle 52 is coupled to the actuator element 3 such that the actuator element 3 can be displaced by the threaded spindle 52 at least in the first direction 4. The spindle gear 49 is arranged in an axial opening 53 of the transmission housing 12.

The transmission device 27 also has an additional gear wheel 54. The further gear wheel 54 is arranged for conjoint rotation on the spindle nut 50. An output toothing 55 of the gear wheel 48 meshes with an input toothing 56 of the further gear wheel 54. Thus, the additional gear wheel 54 can be rotated by turning the gear wheel 48. Accordingly, the spindle gear 49 can be driven or rotated by the electrical machine 22.

According to the exemplary embodiment shown in FIG. 3, the motor shaft 25 is mounted on a side of the electrical machine 22 facing the planetary transmission 28 by the ring gear 45. For this purpose, the ring gear 45 has a sleeve-shaped bearing portion 57, which radially surrounds the motor shaft 25 between the sun gear 29 and the rotor 24. The bearing portion 57 forms a plain bearing for the motor shaft 25. On a side of the electrical machine 22 facing away from the planetary transmission 28, the motor shaft 25 is supported by a base 58 of the motor housing 14. For this purpose, the base 58 carries a rolling element bearing 59, which acts between the motor shaft 25 and the base 58.

The actuating device 1 also has a control unit 70, which is designed to control the electrical machine 22. The control unit 70 is arranged on the motor housing 14 on a side of the electrical machine 22 facing away from the planetary transmission 28.

The actuating device 1 also has an actuating element 60, which is displaceably mounted in an axial opening 61 of the threaded spindle 52. A first end 62 of the actuating element 60 can be coupled or is coupled to a brake pedal of the brake system 2 by an input rod 63, so that the actuating element 60 can then be displaced by pressing the brake pedal. A second end 64 of the actuating element 60 is coupled to the actuator element 3 such that the actuator element 3 can be displaced by the actuating element 60. Thus, the friction brake devices can also be actuated by pressing the brake pedal.

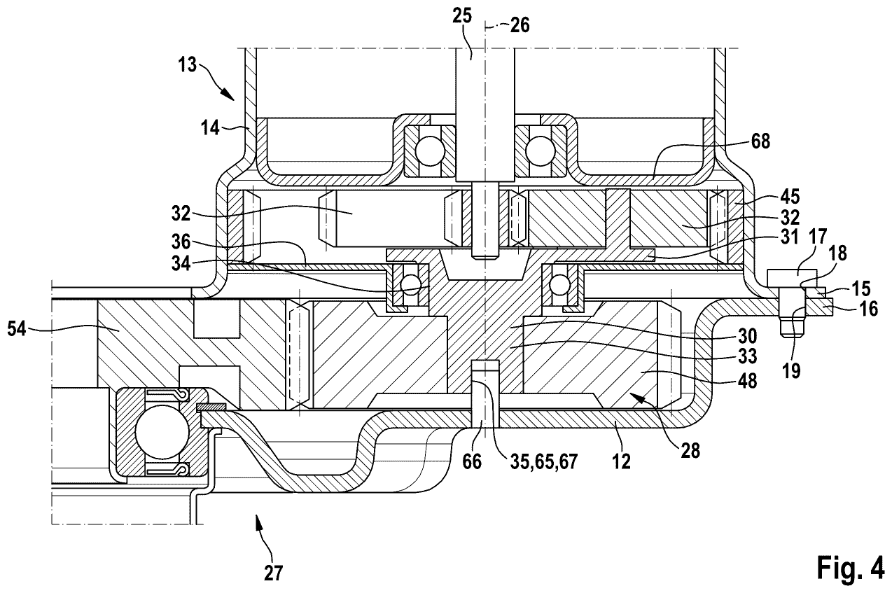

FIG. 4 shows the drive unit 13 according to a further exemplary embodiment. The exemplary embodiment shown in FIG. 4 differs from the exemplary embodiment shown in FIG. 3 in particular in that the end plate 36 abuts the motor housing 14 radially from the inside. For example, the end plate 36 is pressed into the motor housing 14. The motor housing flange 15 directly abuts the transmission housing flange 16. In addition, the output shaft 33 in the exemplary embodiment shown in FIG. 4 has an end-face recess 65. A bearing pin 66 fastened to the transmission housing 12 engages in the end-face recess 65 for mounting the output shaft 33. In the exemplary embodiment shown in FIG. 4, the second bearing point 35 is correspondingly formed by a casing inner surface 67 of the output shaft 33 forming the recess 65. Furthermore, the motor shaft 25 is not supported by the ring gear 45 in the exemplary embodiment shown in FIG. 4. Instead, the drive unit 13 has a further end plate 68 fixed to the housing, which end plate is arranged between the planetary transmission 28 and the electrical machine 22 and supports the motor shaft 25.

When assembling the actuating device 1, the procedure is preferably such that a preassembly is initially provided, which comprises at least the motor housing 14, the electrical machine 22, the planetary transmission 28 and the end plate 36. The motor housing 14 is then arranged on the transmission housing 12 such that the motor housing flange 15 is opposite the transmission housing flange 16. Subsequently, a desired alignment of the motor housing 14 relative to the transmission housing 12 is achieved by inserting a dowel pin through, in each case, a pair of alignment openings 20 and 21. If the end plate flange 39 is arranged between the motor housing flange 15 and the transmission housing flange 16, the dowel pins are also inserted through the third alignment openings 41, so that the dowel pins also achieve the desired alignment of the end plate 36. Due to the dowel pins inserted into the alignment openings 20, 21 and 41, a particularly precise definition of the position of the elements involved can be achieved. For example, it can be achieved that the planet carrier 30 is aligned at least substantially parallel to the axis of the motor shaft 25. Subsequently, the transmission housing 12 is fastened to the motor housing 14 by the fastening means 17, wherein the alignment defined by the dowel pins is maintained. Because the alignment is now fixed by the fastening means 17, the dowel pins are preferably removed. The exemplary embodiment with which the end plate flange 39 is arranged between the motor housing flange 15 and the transmission housing flange 16 is particularly advantageous, because the alignment of the end plate 36 is directly defined by the dowel pins. In this respect, the tolerance chain with regard to the alignment or arrangement of the end plate 36 is minimized.

1-15. (canceled)

16. A drive unit for an actuating device of a brake system, comprising:
a motor housing;
an electrical machine arranged in the motor housing, wherein a rotor of the electrical machine is arranged for conjoint rotation on a motor shaft mounted rotatably in the motor housing;
a planetary transmission using which the motor shaft is connected or connectable to an actuator element of the actuating device, wherein the planetary transmission has a rotatably mounted planet carrier, and wherein the planet carrier has a carrier portion on which at least one planet gear is rotatably mounted; and
an end plate arranged on the motor housing, by way of which end plate the planet carrier is mounted on a side of the planet gear facing away from the electrical machine.

17. The drive unit according to claim 16, wherein the end plate carries a rolling element bearing for mounting the planet carrier.

18. The drive unit according to claim 16, wherein the end plate abuts the motor housing radially from the inside.

19. The drive device according to claim 16, wherein the end plate axially abuts a motor housing flange of the motor housing.

20. The drive unit according to claim 16, wherein the planet carrier has an output shaft, and the end plate supports the output shaft.

21. The drive unit according to claim 20, wherein the carrier portion is arranged in the motor housing, and the output shaft protrudes out of the motor housing.

22. The drive unit according to claim 16, wherein the end plate supports a first bearing point of the planet carrier, and the planet carrier has a second bearing point which is arranged on a side of the first bearing point facing away from the electrical machine and is spaced apart from the first bearing point.

23. The drive unit according to claim 16, wherein the drive unit has a further end plate which is arranged between the planetary transmission and the electrical machine and supports the motor shaft.

24. An actuating device for a brake system, comprising:
an actuator element; and
a drive unit configured to drive the actuator element, the drive unit including:
a motor housing,
an electrical machine arranged in the motor housing, wherein a rotor of the electrical machine is arranged for conjoint rotation on a motor shaft mounted rotatably in the motor housing,
a planetary transmission using which the motor shaft is connected or connectable to the actuator element, wherein the planetary transmission has a rotatably mounted planet carrier, and wherein the planet carrier has a carrier portion on which at least one planet gear is rotatably mounted, and
an end plate arranged on the motor housing, by way of which end plate the planet carrier is mounted on a side of the planet gear facing away from the electrical machine.

25. The actuating device according to claim 24, further comprising:
a transmission housing fastened to the motor housing, wherein the end plate supports a first bearing point of the planet carrier, and the planet carrier has a second bearing point which is arranged on a side of the first bearing point facing away from the electrical machine and is spaced apart from the first bearing point, and wherein the second bearing point of the planet carrier is supported by the transmission housing.

26. The actuating device according to claim 25, wherein the transmission housing carries a rolling element bearing for mounting the planet carrier.

27. The actuating device according to claim 25, wherein the transmission housing has a bearing pin which is fixed to the transmission housing and engages in an end-face recess of the planet carrier for mounting the planet carrier.

28. The actuating device according to claim 25, wherein the end plate axially abuts a motor housing flange of the motor housing, wherein the motor housing flange of the motor housing has a plurality of first fastening openings, a transmission housing flange of the transmission housing has a plurality of second fastening openings, each of the first fastening openings is aligned with, in each case, one of the second fastening openings, and wherein the transmission housing is fastened to the motor housing by a fasteners inserted into the fastening openings.

29. The actuating device according to claim 28, wherein the fasteners are dowel screws.

30. The actuating device according to claim 25, wherein the end plate axially abuts a motor housing flange of the motor housing, wherein the motor housing flange has a plurality of first alignment openings, the transmission housing flange has a plurality of second alignment openings, each of the first alignment openings is aligned with one of the second alignment openings, and the first and second alignment openings are unoccupied.
